(19) United States
(12) Patent Application Publication
(10) Pub. No.: US 2019/0152554 A1
(43) Pub. Date: May 23, 2019

(54) ELECTRIC SCOOTER

(71) Applicant: SUZHOU DYNAVOLT INTELLIGENT VEHICLE TECH. Co., Ltd, Suzhou (CN)

(72) Inventor: Xiansheng ZENG, Suzhou (CN)

(21) Appl. No.: 16/317,799

(22) PCT Filed: Sep. 21, 2016
(86) PCT No.: PCT/CN2016/099640

§ 371 Date: Jan. 14, 2019

(30) Foreign Application Priority Data
Jul. 14, 2016 (CN) 201610554295.6

(51) Int. Cl. B62K 11/02; B62K 15/00; B62L 3/00; B62J 15/00; B62K 21/02; B62K 21/12; B62K 23/00; B62J 99/00; B62J 6/02; B62J 6/04

(52) U.S. Cl. CPC B62K 11/02; B62K 15/006; B62L 3/00; B62J 15/00; B62K 21/02; B62K 21/12; B62J 2099/0026; B62J 99/00; B62J 6/02; B62J 6/04; B62K 2202/00; B62K 2204/00; B62K 23/00

(57) ABSTRACT

An electric scooter includes an arc-shaped body, a front frame disposed at a front end of the body, a front wheel connected to a bottom of the front frame, a folding mechanism connected between the body and the front frame, and a rear wheel connected to a rear end of the body. The electric scooter further includes a control device and a drive motor drive-connected to the rear wheel through a transmission shaft. The control device includes a controller, an electromagnetic brake switch connected to the front frame and configured to control a braking operation of the electric scooter, and an electromagnetic speed regulating switch configured to control a speed regulating operation of the electric scooter. The electromagnetic brake switch, the electromagnetic speed regulating switch and the drive motor are all connected to the controller.

### CROSS-REFERENCES TO RELATED APPLICATIONS

This application is a national stage application under 35 U.S.C. 371 based on international patent application PCT/CN2016/099640, filed on Sep. 21, 2016 which claims priority to a Chinese patent application No. 201610554295.6 filed on Jul. 14, 2016, disclosures of both of which are incorporated herein by reference in their entireties.

### TECHNICAL FIELD

The present disclosure relates to the field of scooters, for example, to an electric scooter.

### BACKGROUND

With economic development, many social problems have become increasingly apparent such as energy shortage, increasingly serious vehicle emission pollution and urban traffic jams. In recent years, electric vehicles have become more and more popular among consumers as a new generation of convenient transportation. An electric scooter is an emerging short-distance means of transportation that is favored by consumers because it can be carried around. Portability is an important factor for consumers to consider when choosing the electric scooter.

### SUMMARY

The present disclosure provides an electric scooter, which has a simple structure, occupies small space and is convenient to carry.

Embodiments of the present application provide an electric scooter, including: an arc-shaped body, a front frame disposed at a front end of the body, a front wheel connected to a bottom of the front frame, a folding mechanism connected between the body and the front frame, and a rear wheel connected to a rear end of the body;

where the electric scooter further includes a control device and a drive motor drive-connected to the rear wheel through a transmission shaft; and

where the control device includes a controller, an electromagnetic brake switch connected to the front frame and configured to control a braking operation of the electric scooter and an electromagnetic speed regulating switch configured to control a speed regulating operation of the electric scooter; and the electromagnetic brake switch, the electromagnetic speed regulating switch and the drive motor are all connected to the controller.

Optionally, the folding mechanism includes a fixed base and a rotating member rotatably connected to the fixed base;

where the fixed base is connected to the front end of the body, and the rotating member is connected to the front frame;

the fixed base is provided with a first guiding groove in a transverse direction and a second guiding groove in a longitudinal direction; and a first positioning groove, a second positioning groove and a third positioning groove spaced apart from each other are disposed on an edge of a peripheral side of the rotating member; where the first positioning groove corresponds to the first guiding groove, and the second positioning groove and the third positioning groove both correspond to the second guiding groove;

the folding mechanism further includes a first positioning rod disposed in the first guiding groove and a second positioning rod disposed in the second guiding groove; where the first positioning rod is connected to a first drive mechanism for driving the first positioning rod to move transversely along the first guiding groove; and the second positioning rod is connected to a second drive mechanism for driving the second positioning rod to move longitudinally along the second guide groove;

when the electric scooter is folded, the rotating member is configured to enable the first positioning groove to correspond to the first guiding groove and enable the second positioning groove to correspond to the second guiding groove at the same time; the first drive mechanism is configured to drive the first positioning rod to enter into the first positioning groove, and the second drive mechanism is configured to drive the second positioning rod to enter into the second positioning groove; and

when the electric scooter is folded, the rotating member is configured to enable the third positioning groove to correspond to the second guiding groove, and the second drive mechanism is configured to drive the second positioning rod into the third positioning groove.

Optionally, the first drive mechanism includes a first drive rod, a cam and a first spring; and the second drive mechanism includes a second drive rod, a second spring and a handle.

Optionally, a U-shaped groove for accommodating the rear wheel is disposed at the rear end of the body, and the rear wheel is mounted in the U-shaped groove; an arc-shaped fender is disposed above the U-shaped groove and a front end of the fender is connected to the body; two sides of the fender are symmetrically connected to protruding fender aprons, a bottom of each of the fender aprons is connected to a top surface of the body; where the body, the fender and the fender aprons are integrally molded of carbon fiber composite materials.

Optionally, a top surface of the body is provided with a storage battery compartment for accommodating a storage battery; an end of the storage battery compartment adjacent to the rear end of the body is provided with a controller compartment for accommodating the controller; and a receiving cavity for accommodating electric wires is disposed inside each of two sides of the body.

Optionally, the front frame includes a handlebar, a vertical rod, a front fork, and a vertical rod connecting member;

where the vertical rod is disposed at a bottom of the handlebar, and is integrally formed with the handlebar; the front fork is connected to a bottom of the vertical rod; the vertical rod connecting member is sleeved on an outer side of the front fork; a top of the vertical rod connecting member is rotatably connected to the vertical rod, and a bottom of the vertical rod connecting member is rotatably connected to a top of the front fork.

Optionally, the top of the vertical rod connecting member is rotatably connected to the vertical rod through an upper bearing; and the bottom of the vertical rod connecting member is rotatably connected to the top of the front fork through a lower bearing.

Optionally, the electromagnetic brake switch includes a U-shaped base, a Hall element, an arc-shaped magnetic steel disposed adjacent to the Hall element, and a clamp for clamping the magnetic steel;

where the Hall element is connected to the controller; the clamp is rotatably connected to the base; and the clamp is connected to a drive mechanism for driving the clamp to rotate.

Optionally, the drive mechanism includes a drive rod connected to the clamp and a button disposed at an opening of the base; and

where a first end of the button is hingedly connected to an end of the drive rod and a second end of the button is rotatably connected to the base through a connecting shaft.

Optionally, the electromagnetic speed regulating switch and the electromagnetic brake switch are symmetrically arranged.

Optionally, a clutch is connected between the drive motor and the transmission shaft, and the clutch is connected to the controller; and the front frame is provided with a clutch switch for controlling the clutch, and the clutch switch is connected to the controller.

Optionally, the front frame is provided with a display screen.

Optionally, the electric scooter further includes: a light system, where the light system includes a light switch, a headlight and a marker light at a front side of the front frame, and a taillight at the rear end of the body.

The embodiments of the present application provide the electric scooter with a streamlined design, which has a beautiful appearance and is lighter in weight and convenient to carry.

### BRIEF DESCRIPTION OF DRAWINGS

One or more embodiments are exemplarily illustrated by way of corresponding drawings. Such exemplary illustration does not limit the embodiments. Components having the same reference numerals in the drawings are similar components. Unless specifically stated, the drawings are not scale-limiting.

FIG. 1 is a schematic perspective view of an electric scooter according to an embodiment of the present application;

FIG. 2 is an exploded view of a front frame in FIG. 1;

FIG. 3 is an exploded view of a folding mechanism in FIG. 1;

FIG. 4 is a schematic perspective view of a body in FIG. 1;

FIG. 5 is a schematic perspective view of a body in FIG. 1 from another angle; and

FIG. 6 is a structural view of an electromagnetic brake switch in FIG. 1.

In the drawings: 1—front frame; 11—handlebar; 12—vertical rod; 13—front fork; 14—vertical rod connecting member; 15—upper bearing; 16—lower bearing; 17—locking assembly; 2—body; 21—U-shaped groove; 22—fender; 23—fender apron; 24—storage battery compartment; 25—controller compartment; 26—charging hole; 27—connecting portion; 271—rear clamping groove; 272—groove; 28—cover plate; 29—support; 3—folding mechanism; 31—fixed base; 311—first guiding groove; 312—second guiding groove; 32—rotating shaft; 34—first positioning rod; 35—second positioning rod; 36—first drive mechanism; 361—first drive rod; 362—cam; 363—first spring; 37—second drive mechanism; 371—second drive rod; 372—second spring; 373—handle; 38—wrench; 4—Drive motor; 5—front wheel; 6—rear wheel; 7—electromagnetic brake switch; 71—base; 72—Hall element; 73—magnetic steel; 74—clamp; 75—drive mechanism; 751—button; 752—drive rod; 76—connecting shaft; 77—torsion spring; 78—limiting block; 8—electromagnetic speed regulating switch; 9—display screen.

### DETAILED DESCRIPTION

The technical solutions of the present application are described hereinafter through specific embodiments in conjunction with the drawings. If not in collision, features in the embodiments may be combined with each other.

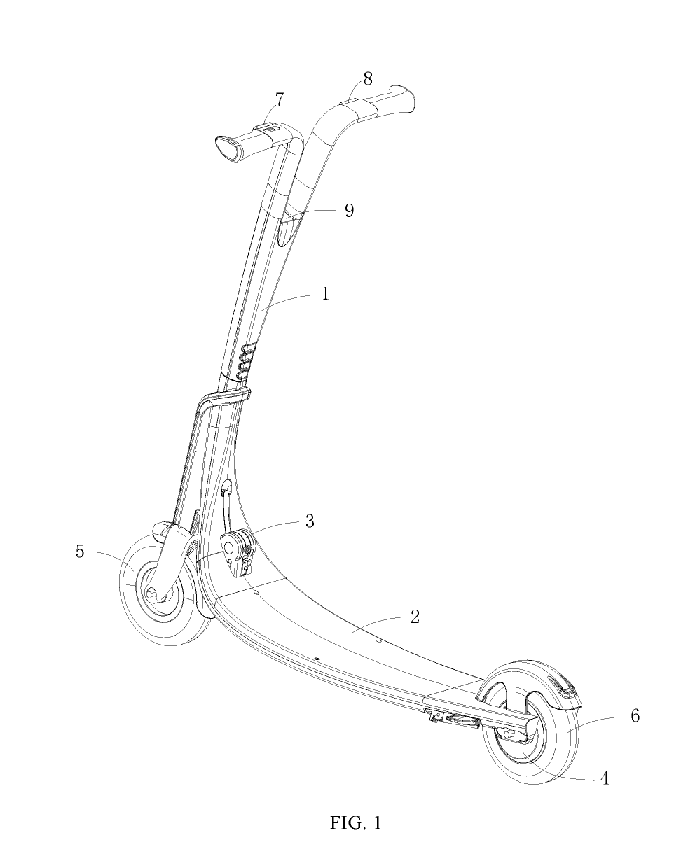

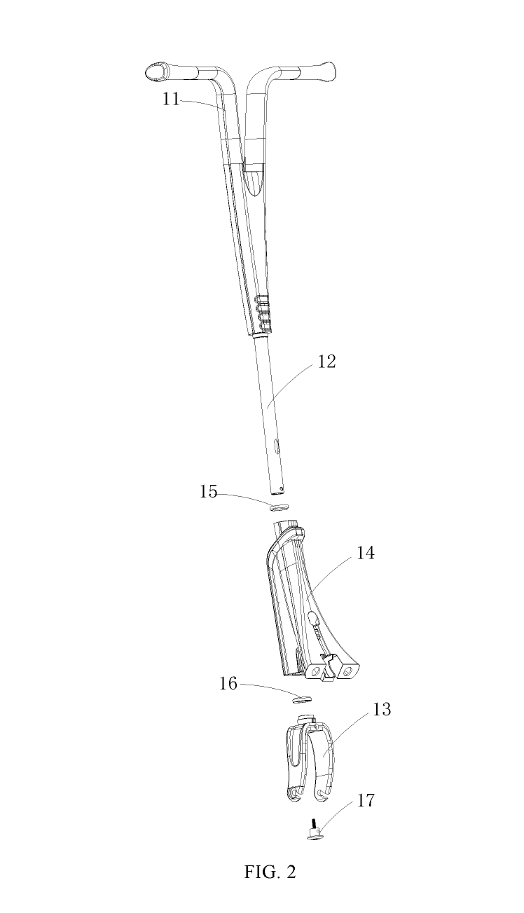

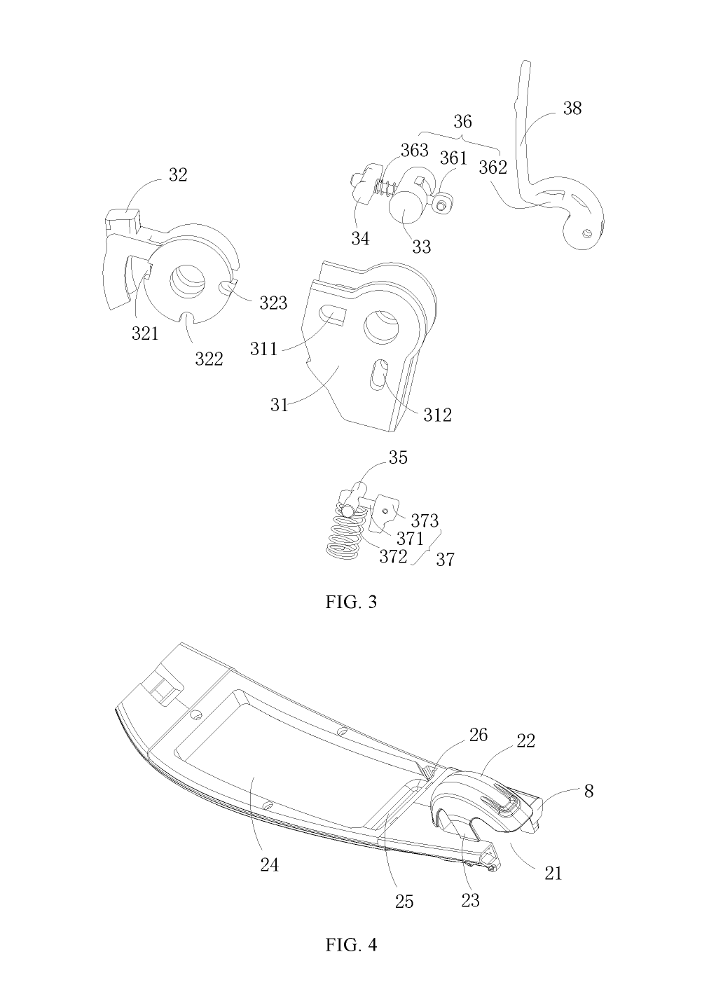

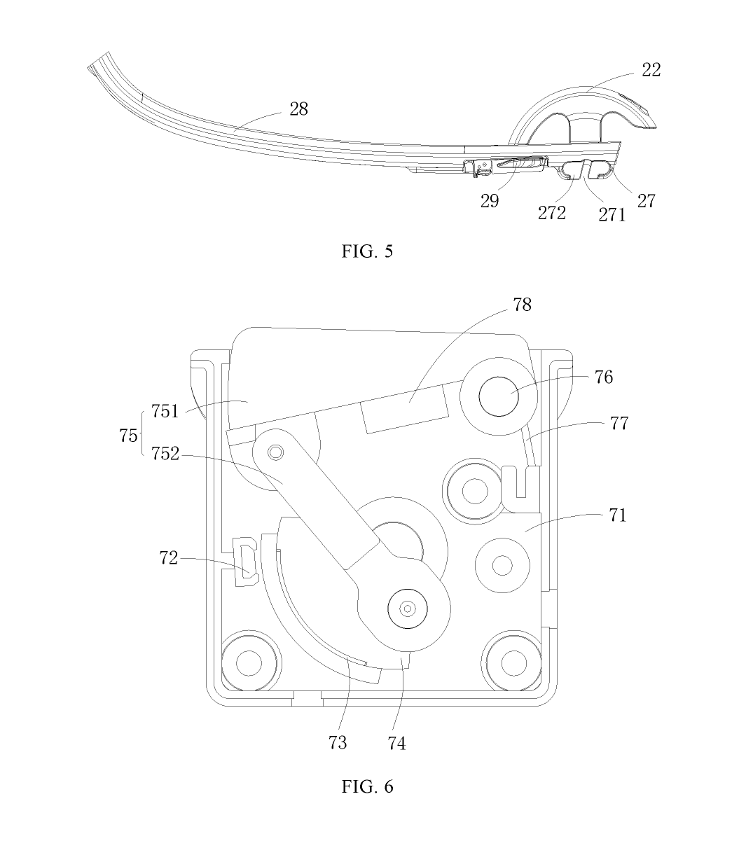

As shown in FIG. 1 to FIG. 6, an electric scooter includes an arc-shaped body 2, a front frame 1 disposed at a front end of the body 2, a front wheel 5 connected to a bottom of the front frame 1, a folding mechanism 3 connected between the body 2 and the front frame 1, and a rear wheel 6 connected to a rear end of the body 2. The electric scooter further includes a control device and a drive motor drive-connected to the rear wheel 6 through a transmission shaft. The control device includes a controller, an electromagnetic brake switch 7 connected to the front frame 1 and configured to control a braking operation of the electric scooter, and an electromagnetic speed regulating switch 8 configured to control a speed regulating operation of the electric scooter. The electromagnetic brake switch 7, the electromagnetic speed regulating switch 8 and the drive motor 4 are all connected to the controller. The electric scooter adopts a streamlined design with a beautiful appearance, which is simple in structure, foldable to occupy small space and convenient to carry.

In the electric scooter, the front frame 1 includes a handlebar 11, a vertical rod 12, a front fork 13, and a vertical rod connecting member 14. The vertical rod 12 is disposed at a bottom of the handlebar 11, and is integrally formed with the handlebar 11. The front fork 13 is connected to a bottom of the vertical rod 12. The vertical rod connecting member 14 is sleeved on an outer side of the front fork 13. A top of the vertical rod connecting member 14 is rotatably connected to the vertical rod 12, and a bottom of the vertical rod connecting member 14 is rotatably connected to a top of the front fork 13. The handlebar 11 includes a left handlebar and a right handlebar which are symmetrically arranged. The left handlebar and the right handlebar are respectively provided with a handlebar sleeve; a peripheral side of the left handlebar and a peripheral side of the right handlebar are respectively provided with a protrusion to prevent the handlebar sleeve from rotating around the left handlebar or the right handlebar. The top of the vertical rod connecting member 14 is rotatably connected to the vertical rod 12 through an upper bearing 15, and an internal structure at the top of the vertical rod connecting member 14 cooperates with an external structure at a top of the vertical rod 12 to limit the upper bearing 15 in an axial direction. The bottom of the vertical rod connecting member 14 is rotatably connected to the top of the front fork 13 through a lower bearing 16, and an internal structure at the bottom of the vertical rod connecting member 14 cooperates with an external structure at the top of the front fork 13 to limit the lower bearing 16 in the axial direction. The bottom of the vertical rod 12 is secured to the front fork 13 through a locking assembly 17. Front clamping grooves are obliquely disposed at a bottom of the front fork 13 and the front clamping grooves are configured to clamp a front axle of the front wheel 5.

In the electric scooter, a U-shaped groove 21 for accommodating the rear wheel 6 is disposed at the rear end of the body 2, and the rear wheel 6 is mounted in the U-shaped groove 21. An arc-shaped fender 22 is disposed above the U-shaped groove 21 disposed at the rear end of the body 2. A front end of the fender 22 is connected to the body 2; both sides of the fender 22 are symmetrically connected to protruding fender aprons 23. A bottom of each fender apron 23 is connected to a top surface of the body 2. The body 2, the fender 22 and the fender aprons 23 are integrally molded of carbon fiber composite materials. The body 2 has a beautiful structure which can effectively prevent muds from splashing and reduce pollution of the body. The use of the carbon fiber composite materials reduces weight of the electric scooter to make it convenient to carry. The integral molding process adopted simplifies an assembly process of the electrical scooter; and the structure of the whole body 2 is not welded so that the body 2 has a strong energy absorption buffering capability and high impact strength. In addition, the top surface, a bottom surface and both sides of the body 2 all adopt a curve design to make a unique and fashionable appearance; moreover, a width of a front part of the body 2 is slightly larger than a width of a rear part of the body 2 to make the design of the whole body 2 conform to the man-machine engineering concept. The top surface of the body 2 is provided with a storage battery compartment 24 for accommodating a storage battery. An end of the storage battery compartment 24 adjacent to the rear end of the body 2 is provided with a controller compartment 25 for accommodating the controller; and a side portion of the storage battery compartment 24 is provided with a charging hole 26. A receiving cavity for accommodating electric wires is disposed inside each of two sides of the body 2 so that the electric wires can be hidden in the receiving cavity, thereby making a beautiful appearance of the electrical scooter, preventing the electric wires from being damaged and providing higher safety. The rear end of the body 2 is provided with connecting portions 27 for connecting the rear wheel 6. A bottom of each of the connecting portions 27 is provided with a rear clamping groove 271 for clamping the transmission shaft and disposed obliquely. A stiffening plate is connected to an outer side of each of the connecting portions 27 to reinforce a structural strength of the connecting portions 27. The outer side of each of the connecting portions 27 is provided with a groove 272 for placing the stiffening plate, and an inner dimension of the groove 272 fits an outer dimension of the stiffening plate. A support 29 is connected to a side of the bottom surface of the body 2 and the support 29 may be hidden at the bottom of the body 2. A U-shaped cover plate 28 is disposed above the storage battery compartment 24 and the controller compartment 25. The cover plate 28 is detachably connected to the body 2 and a top surface of the cover plate 28 may be attached with an abrasive paper to provide an anti-slip effect.

In the electric scooter, the folding mechanism 3 includes a fixed base 31 and a rotating member 32 rotatably connected to the fixed base 31 through a rotating shaft 33. The fixed base 31 is connected to the front end of the body 2 and the rotating member 32 is connected to the front frame 1. Optionally, the rotating member 32 is connected to the bottom of the vertical rod connecting member 14 or integrally formed with the vertical rod connecting member 14. The fixed base 31 is provided with a first guiding groove 311 in a transverse direction and a second guiding groove 312 in a longitudinal direction. A first positioning groove 321, a second positioning groove 312 and a third positioning groove 323 which are spaced apart from each other are disposed on an edge of a peripheral side of the rotating member 32. The first positioning groove 321 may correspond to the first guiding groove 311; and the second positioning groove 322 and the third positioning groove 323 may both correspond to the second guiding groove 312. The folding mechanism 3 further includes a first positioning rod 34 disposed in the first guiding groove 311 and a second positioning rod 35 disposed in the second guiding groove 312. The first positioning rod 34 is connected to a first drive mechanism 36 for driving the first positioning rod 34 to move transversely along the first guiding groove 311. The second positioning rod 35 is connected to a second drive mechanism 37 for driving the second positioning rod 35 to move longitudinally along the second guide groove 312.

When the electric scooter is folded, the rotating member 32 is configured to enable the first positioning groove 321 to correspond to the first guiding groove 311 and enable the second positioning groove 322 to correspond to the second guiding groove 312 at the same time. At this time, the first drive mechanism 36 is configured to drive the first positioning rod 34 to enter into the first positioning groove 321, and the second drive mechanism 37 is configured to drive the second positioning rod 35 to enter into the second positioning groove 322. The first positioning rod 34 is located in both the first guiding groove 311 and the first positioning groove 321, and the second positioning rod 35 is located in both the second guiding groove 312 and the second positioning groove 322; therefore, the folding mechanism 3 is in a double-locked state after the electric scooter is unfolded and the rotating member 32 cannot rotate related to the fixed base 31, providing higher safety.

When the electric scooter is folded, the rotating member 32 is configured to enable the third positioning groove 323 to correspond to the second guiding groove 312, and the second drive mechanism 37 is configured to drive the second positioning rod 35 to enter into the third positioning groove 323. At this time, the first positioning rod 34 does not enter into the first positioning groove 321. Therefore, the folding mechanism 3 is in a locked state after the electric scooter is folded, and the rotating member 32 cannot rotate related to the fixed base 31. It should be noted that when the first positioning rod 34 is separate from the first positioning groove 321 and the second positioning rod 35 is separate from the second positioning groove 322 and the third positioning groove 323, the folding mechanism 3 is in an unlocked state and the front frame 1 may rotate with respect to the body 2. During the electric scooter is ridden, the folding mechanism 3 is in the double-locked state after the electric scooter is unfolded and is less likely to shake, providing higher safety.

Optionally, the first drive mechanism 36 includes a first drive rod 361, a cam 362 and a first spring 363. A first end of the first drive rod 361 is connected to the cam 362 by a cam shaft and a second end of the first drive rod 361 penetrates through the rotating shaft 33 along a radial direction of the rotating shaft 33 to be connected to the first positioning rod 34. The first spring 363 sleeves on the first drive rod 361 between the first positioning rod 34 and the rotating shaft 33. The cam 362 is connected to a wrench 38. The second drive mechanism 37 includes a second drive rod 371, a second spring 372 and a handle 373. A first end of the second drive rod 371 is connected with the handle 373 and a second end of the second drive rod 371 is connected to the second positioning rod 35. A top of the second spring 372 is connected to a bottom of the second positioning rod 35 and a bottom of the second spring 372 abuts against an inner bottom surface of the fixed base 31. The handle 373 is slidably connected to the fixed base 31.

In the electric scooter, the electromagnetic brake switch 7 includes a U-shaped base 71, a Hall element 72, an arc-shaped magnetic steel 73 disposed adjacent to the Hall element 72 and a clamp 74 for clamping the magnetic steel 73. The Hall element 72 is connected to the controller. The clamp 74 is rotatably connected to the base 71 and the clamp 74 is connected to a drive mechanism 75 for driving the clamp 74 to rotate. As an optional embodiment of the solution, the drive mechanism 75 includes a drive rod 752 connected to the clamp 74 and a button 751 disposed at an opening of the base 71. A first end of the button 751 is hingedly connected to an end of the drive rod 752, and a second end of the button 751 is rotatably connected to the base 71 through a connecting shaft 76. A torsion spring 77 sleeves on the connecting shaft 76. A first end of the torsion spring 77 abuts against an inner side of the button 751 and a second end of the torsion spring 77 is connected to the base 71. A limiting block 78 is disposed between the clamp 74 and the button 751 and is configured to limiting a rotation angle of the magnetic steel 73. The button 751 is pressed by a finger when the electrical scooter needs to brake. When the button 751 is released, the button 751 returns to its original position under an elastic restoring force of the torsion spring 77. By pressing the electromagnetic brake switch 7, an output voltage of the Hall element 72 linearly changes; the controller receives the output voltage of the Hall element 72 and controls the deceleration and braking of the drive motor 4 according to changes of the output voltage, reducing losses and achieving easy and safe braking.

In the electric scooter, the electromagnetic speed regulating switch 8 and the electromagnetic brake switch 7 have symmetrical structures. A speed regulating principle of the electric scooter is similar to the above braking principle of the electric scooter. When the electromagnetic speed regulating switch 8 is pressed, the controller controls the drive motor 4 to perform speed regulation according to changes of an output voltage of a Hall element in the electromagnetic speed regulating switch 8. The push type speed regulation manner is easier to operate and safer to use than a speed regulation manner by rotating a handle in the existing art. Some parts in the electromagnetic brake switch 7 and the electromagnetic speed regulating switch 8 may be used in common, thereby improving universality of the parts and reducing production costs. The electromagnetic brake switch 7 and the electromagnetic speed regulating switch 8 have a small and beautiful appearance; and the electromagnetic brake switch 7 is embedded in the left handlebar and the electromagnetic speed regulating switch 8 is embedded in the right handlebar, occupying a small space.

In the electric scooter, a clutch is connected between the drive motor 4 and the transmission shaft, and the clutch is connected to the controller. The front frame 1 is provided with a clutch switch for controlling the clutch and the clutch switch is connected to the controller. In a riding process, the controller controls the clutch to enable the drive motor 4 to be drive-connected to the transmission shaft so that the drive motor 4 can drive the speed regulation, braking and other functions of the electric scooter. When the battery is dead or a user needs to ride the electric scooter himself, the clutch switch is pressed to disconnect the drive motor 4 from the transmission shaft.

In the electric scooter, the front frame 1 is provided with a display screen 9 connected to the controller. Performance parameters such as the speed, voltage and riding time of the electric scooter can be clearly understood through the display screen 9.

The electric scooter further includes a light system including a light switch, a headlight and a marker light at a front side of the front frame 1 and a taillight at the rear end of the body 2. The light switch is connected to the controller, and the controller is connected with an LED drive module for driving the headlight, the marker light and the taillight to operate. The headlight can adjust its brightness according to the brightness of the surrounding environment, achieving energy saving and environmental protection.

The present application is described above in conjunction with the embodiments. The description is merely configured to explaining the present application, and is not intended to be explained in any means as limitations to the present application.

1. An electric scooter, comprising: an arc-shaped body, a front frame disposed at a front end of the body, a front wheel connected to a bottom of the front frame, a folding mechanism connected between the body and the front frame, and a rear wheel connected to a rear end of the body;
wherein the electric scooter further comprises a control device and a drive motor drive—connected to the rear wheel through a transmission shaft; and
wherein the control device comprises a controller, an electromagnetic brake switch connected to the front frame and configured to control a braking operation of the electric scooter and an electromagnetic speed regulating switch configured to control a speed regulating operation of the electric scooter; and the electromagnetic brake switch, the electromagnetic speed regulating switch and the drive motor are all connected to the controller.

2. The electric scooter of claim 1, wherein the folding mechanism comprises a fixed base and a rotating member rotatably connected to the fixed base;
wherein the fixed base is connected to the front end of the body, and the rotating member is connected to the front frame;
the fixed base is provided with a first guiding groove in a transverse direction and a second guiding groove in a longitudinal direction; and a first positioning groove, a second positioning groove and a third positioning groove spaced apart from each other are disposed on an edge of a peripheral side of the rotating member; wherein the first positioning groove corresponds to the first guiding groove, and the second positioning groove and the third positioning groove both correspond to the second guiding groove;
the folding mechanism further comprises a first positioning rod disposed in the first guiding groove and a second positioning rod disposed in the second guiding groove; wherein the first positioning rod is connected to a first drive mechanism for driving the first positioning rod to move transversely along the first guiding groove; and the second positioning rod is connected to a second drive mechanism for driving the second positioning rod to move longitudinally along the second guide groove;
when the electric scooter is folded, the rotating member is configured to enable the first positioning groove to correspond to the first guiding groove and enable the second positioning groove to correspond to the second guiding groove at the same time; the first drive mechanism is configured to drive the first positioning rod to enter into the first positioning groove, and the second drive mechanism is configured to drive the second positioning rod to enter into the second positioning groove; and
when the electric scooter is folded, the rotating member is configured to enable the third positioning groove to correspond to the second guiding groove, and the second drive mechanism is configured to drive the second positioning rod into the third positioning groove.

3. The electric scooter of claim 2, wherein the first drive mechanism comprises a first drive rod, a cam and a first spring; and
the second drive mechanism comprises a second drive rod, a second spring and a handle.

4. The electric scooter of claim 1, wherein a U-shaped groove for accommodating the rear wheel is disposed at the rear end of the body, and the rear wheel is mounted in the U-shaped groove; an arc-shaped fender is disposed above the U-shaped groove and a front end of the fender is connected to the body; two sides of the fender are symmetrically connected to protruding fender aprons, a bottom of each of the fender aprons is connected to a top surface of the body; wherein the body, the fender and the fender aprons are integrally molded of carbon fiber composite materials.

5. The electric scooter of claim 1, wherein a top surface of the body is provided with a storage battery compartment for accommodating a storage battery; an end of the storage battery compartment adjacent to the rear end of the body is provided with a controller compartment for accommodating the controller; and a receiving cavity for accommodating electric wires is disposed inside each of two sides of the body.

6. The electric scooter of claim 1, wherein the front frame comprises a handlebar, a vertical rod, a front fork, and a vertical rod connecting member;
wherein the vertical rod is disposed at a bottom of the handlebar, and is integrally formed with the handlebar; the front fork is connected to a bottom of the vertical rod; the vertical rod connecting member is sleeved on an outer side of the front fork; a top of the vertical rod connecting member is rotatably connected to the vertical rod, and a bottom of the vertical rod connecting member is rotatably connected to a top of the front fork.

7. The electric scooter of claim 6, wherein the top of the vertical rod connecting member is rotatably connected to the vertical rod through an upper bearing; and the bottom of the vertical rod connecting member is rotatably connected to the top of the front fork through a lower bearing.

8. The electric scooter of claim 1, wherein the electromagnetic brake switch comprises a U-shaped base, a Hall element, an arc-shaped magnetic steel disposed adjacent to the Hall element, and a clamp for clamping the magnetic steel;
wherein the Hall element is connected to the controller; the clamp is rotatably connected to the base; and the clamp is connected to a drive mechanism for driving the clamp to rotate.

9. The electric scooter of claim 8, wherein the drive mechanism comprises a drive rod connected to the clamp and a button disposed at an opening of the base;
wherein a first end of the button is hingedly connected to an end of the drive rod, and a second end of the button is rotatably connected to the base through a connecting shaft.

10. The electric scooter of claim 1, wherein the electromagnetic speed regulating switch and the electromagnetic brake switch are symmetrically arranged.

11. The electric scooter of claim 1, wherein a clutch is connected between the drive motor and the transmission shaft, and the clutch is connected to the controller; and the front frame is provided with a clutch switch for controlling the clutch, and the clutch switch is connected to the controller.

12. The electric scooter of claim 1, wherein the front frame is provided with a display screen.

13. The electric scooter of claim 1, further comprising: a light system, wherein the light system comprises a light switch, a headlight and a marker light at a front side of the front frame, and a taillight at the rear end of the body.

14. The electric scooter of claim 4, wherein a top surface of the body is provided with a storage battery compartment for accommodating a storage battery; an end of the storage battery compartment adjacent to the rear end of the body is provided with a controller compartment for accommodating the controller; and a receiving cavity for accommodating electric wires is disposed inside each of two sides of the body.

15. The electric scooter of claim 8, wherein the electromagnetic speed regulating switch and the electromagnetic brake switch are symmetrically arranged.
